(19) United States
(12) Patent Application Publication
(10) Pub. No.: US 2016/0319213 A1
(43) Pub. Date: Nov. 3, 2016

(54) GREASE FOR ROLLING BEARING OF INFORMATION RECORDING AND REPRODUCING APPARATUS, ROLLING BEARING, ROLLING BEARING DEVICE, AND INFORMATION RECORDING AND REPRODUCING APPARATUS

(71) Applicant: SEIKO INSTRUMENTS INC., Chiba-shi (JP)

(72) Inventors: Akihiro IINO, Chiba-shi (JP); Keitaro KOROISHI, Chiba-shi (JP); Hisaya NAKAMURA, Sodegaura-shi (JP); Hiroki YODA, Sodegaura-shi (JP)

(21) Appl. No.: 15/134,519

(22) Filed: Apr. 21, 2016

(30) Foreign Application Priority Data
May 1, 2015 (JP) 2015-094126
Mar. 3, 2016 (JP) 2016-041341

(51) Int. Cl. C10M 169/02; C10M 101/02; G11B 5/48; C10M 115/08; F16C 33/66; G01B 11/06; C10M 105/04

(52) U.S. Cl. CPC C10M 169/02; G01B 11/06; C10M 101/02; C10M 105/04; C10M 115/08; F16C 33/6633; G11B 5/4813; C10M 2203/0206; C10M 2203/003; C10M 2215/1026; C10N 2040/02

(57) ABSTRACT

Grease for a rolling bearing of an information recording and reproducing apparatus 1 contains a base oil and a thickener, wherein the film thickness of an elasto-hydrodynamic lubrication film is 20 nm or greater. Grease for a rolling bearing of an information recording and reproducing apparatus 1 contains a base oil, and a thickener, wherein a width of the thickener in the grease is 20 nm or greater. A rolling bearing includes the grease for a rolling bearing. A rolling bearing device 6 includes a shaft and the rolling bearing. An information recording and reproducing apparatus 1 includes the rolling bearing device 6.

### BACKGROUND OF THE INVENTION

1. Field of the Invention

The present invention relates to grease for a rolling bearing of an information recording and reproducing apparatus, a rolling bearing, a rolling bearing device, and an information recording and reproducing apparatus.

Priority is claimed on Japanese Patent Application No. 2015-094126, filed on May 1, 2015, and Japanese Patent Application No. 2016-041341, filed on Mar. 3, 2016, the content of which is incorporated herein by reference.

2. Description of Related Art

As an apparatus that magnetically or optically records various kinds of information on a disc and reproduces the information, an information recording and reproducing apparatus such as a hard disk drive (HDD) is known. Typically, the information recording and reproducing apparatus includes a swing arm in which a head gimbal assembly (magnetic head) that records a signal on a disc and reproduces the signal is provided at a tip end, a rolling bearing device that becomes a rotation supporting point of the swing arm, and an actuator that rotates the swing arm. When the magnetic head is moved to a predetermined position on the disc by rotating the swing arm, the recording and reproduction of the signal can be performed.

Typically, the rolling bearing device includes two rolling bearings in which a plurality of spherical rolling bodies are provided between an inner ring and an outer ring, and a shaft that is inserted to an inner side of the rolling bearing. The outer ring rotates around an axis of the shaft due to rolling of the plurality of rolling bodies, and the swing arm that is connected to the outer ring rotates along with the rotation. The rolling bearing is required to stably operate over a long period of time. Accordingly, grease is used to make movement of the rolling bodies between the inner ring and the outer ring smooth.

The grease for the rolling bearing of the information recording and reproducing apparatus is required to lower the torque on the rolling bearing, to obtain excellent torque smoothness (a property in which the torque is constant in a rotation direction of the rolling bearings), and to enhance durability of the rolling bearing. In addition, since outgas from the grease collects in a gap between the magnetic head and the disc, a problem relating to reading and writing occurs in the information recording and reproducing apparatus. Accordingly, it is important that the amount of outgas from the grease for the rolling bearing is small.

Along with an increase in density of HDDs, an increase in demand for server use, and the like, an operation range of a swing arm of the HDD, and a range of an operation speed have become wide. According to this, grease, which is provided to a rolling bearing device that becomes a rotation support point of the swing arm, is required to have additional durability.

Under these situations, an examination for enhancing the durability of grease through addition of an additive to the grease, has been performed. For example, Patent Document 1 discloses grease obtained by adding an extreme pressure agent to grease containing a base oil and a thickener.

However, in the disclosure of Patent Document 2, the durability is not sufficiently satisfactory yet. There is a limit for enhancing the durability of grease by adding an additive to grease. In addition, when the additive is added to grease, there is a concern that out-gas characteristics of grease may deteriorate.

### DOCUMENTS OF RELATED ART

### Patent Document

### [Patent Document 1] Japanese Unexamined Patent Application, First Publication No. 2003-239954

### SUMMARY OF THE INVENTION

The invention has been made in consideration of the above-described situations, and an object thereof is to provide grease for a rolling bearing, which is more excellent in durability, of an information recording and reproducing apparatus. In addition, another object of the invention is to provide a rolling bearing using the grease for a rolling bearing, a rolling bearing device, and an information recording and reproducing apparatus.

The present inventors have made a thorough investigation, and as a result, they found that the following grease for a rolling bearing of an information recording and reproducing apparatus is capable of solving the problem.

[1] Grease for a rolling bearing of an information recording and reproducing apparatus, containing:

a base oil; and

a thickener,

wherein the film thickness (h_{C}) of an elasto-hydrodynamic lubrication film, which is measured by the following measurement method, is 20 nm or greater.

<Method of Measuring Film Thickness (h_{C}) of Elasto-Hydrodynamic Lubrication Film>

A steel ball is brought into rolling-contact with a surface of a glass disc to which grease is applied, and the film thickness of a contact region is obtained by a dichromatic interference method.

As the glass disc, a glass disc, in which chromium is deposited on a single surface and which has a diameter of 115 mm, a thickness of 16 mm, and a vertical elastic coefficient of 75 GPa, is used. As the steel ball, a steel ball for a bearing, which has a diameter of 19.05 mm, and a vertical elastic coefficient of 206 GPa, is used.

Grease is applied to a surface of the glass disc on which chromium is deposited. The glass disc and the steel ball are brought into contact with each other under pure rolling conditions of a contact load of 150 N and a maximum hertz pressure of 1.04 GPa. A peripheral velocity of the glass disc is set to 1 mm/s, and ten interference images are obtained for one rotation after initiating an operation of the glass disc. The film thickness at the center of the contact region on the ten interference images is obtained, and an average value thereof is set to h_{C}. An ambient temperature during a test is set to 22.5±0.5°.

[2] The grease for a rolling bearing of an information recording and reproducing apparatus according to [1],

wherein a difference between the maximum value and the minimum value of the film thickness at the contact region is 180 nm or less.

[3] The grease for a rolling bearing of an information recording and reproducing apparatus according to [1] or [2],

wherein the film thickness (h_{C}) is equal to or greater than composite surface roughness of a rolling surface of an inner ring and a rolling body, and composite surface roughness of a rolling surface of an outer ring and the rolling body in the rolling bearing.

[4] Grease for a rolling bearing of an information recording and reproducing apparatus, containing:

a base oil; and

a thickener,

wherein a width of the thickener in the grease is 20 nm or greater.

[5] The grease for a rolling bearing of an information recording and reproducing apparatus according to [4],

wherein the width of the thickener is 150 nm or less.

[6] The grease for a rolling bearing of an information recording and reproducing apparatus according to [4] or [5],

wherein the width of the thickener is equal to or greater than composite surface roughness of a rolling surface of an inner ring and a rolling body, and composite surface roughness of a rolling surface of an outer ring and the rolling body in the rolling bearing.

[7] The grease for a rolling bearing of an information recording and reproducing apparatus according to any one of [1] to [6],

wherein a kinematic viscosity ν of the base oil at 40° C. is 25 mm²/s to 45 mm²/s.

[8] A rolling bearing, comprising:

the grease for a rolling bearing of an information recording and reproducing apparatus according to any one of [1] to [7].

[9] A rolling bearing device, comprising:

a shaft; and

the rolling bearing according to [8]

[10] An information recording and reproducing apparatus, comprising:

the rolling bearing device according to [9].

The grease for a rolling bearing of an information recording and reproducing apparatus of the invention is more excellent in durability.

### BRIEF DESCRIPTION OF THE DRAWINGS

FIG. 1 is a perspective view illustrating an example of an information recording and reproducing apparatus of the invention;

FIG. 2 is a longitudinal cross-sectional view illustrating the periphery of a rolling bearing device in the information-recording and reproducing apparatus in FIG. 1;

FIG. 3 is a cross-sectional view illustrating the rolling bearing device in FIG. 2;

FIG. 4 is a plan view illustrating a rolling bearing in the rolling bearing device in FIG. 3;

FIG. 5 is a cross-sectional view of the rolling bearing in FIG. 4 which is taken along line A-A;

FIG. 6 is a perspective view illustrating a retainer of the rolling bearing in FIG. 5;

FIG. 7 is a schematic view of an apparatus of measuring a film thickness;

FIG. 8A is interference images which are observed with the measurement apparatus in FIG. 7;

FIG. 8B is interference images which are observed with the measurement apparatus in FIG. 7;

FIG. 8C is interference images which are observed with the measurement apparatus in FIG. 7;

FIG. 9 is a SEM image of a thickener of grease in Reference Example 1;

FIG. 10 is a SEM image of a thickener of grease in Example 1.

FIG. 11 is a SEM image of a thickener of grease in Example 2.

### DETAILED DESCRIPTION OF THE INVENTION

Grease for Rolling Bearing of Information Recording and Reproducing Apparatus

Grease (hereinafter, also referred to simply as “grease”) for a rolling bearing of an information recording and reproducing apparatus of the invention contains a base oil and a thickener.

In the grease of the invention, the film thickness (h_{C}) of an elasto-hydrodynamic lubrication (EHL) film, which is measured by the following measurement method, is 20 nm or greater. It is preferable that h_{C} is greater than 20 nm, more preferably 40 μm or greater, and still more preferably 60 μm or greater. When h_{C} is 20 nm or greater, durability is enhanced. On the other hand, although not particularly limited, it is preferably that the upper limit of h_{C} is 300 nm or less when considering that torque smoothness is likely to increase, and more preferably 200 nm or less.

Method of Measuring Film Thickness (h_{C}) of EHL Film

When a steel ball is brought into rolling-contact with a glass disc to which grease is applied, the film thickness in a contact state is obtained as h_{C} by a dichromatic interference method.

As the glass disc, a glass disc, in which chromium is deposited on a single surface and which has a diameter of 115 mm, a thickness of 16 mm, and a vertical elastic coefficient of 75 GPa, is used. As the steel ball, a steel ball for a bearing, which has a diameter of 19.05 mm, and a vertical elastic coefficient of 206 GPa, is used.

First, grease that is an object to be measured is applied to a region, which becomes an orbital surface of the steel ball, on a surface of the glass disc on which chromium is deposited in a thickness of 1 mm.

Next, the glass disc and the steel ball are brought into contact with each other under pure rolling conditions of a contact load of 150 N and the maximum hertz pressure of 1.04 GPa. In addition, a peripheral velocity of the glass disc is set to 1 mm/s, and ten interference images are obtained for one rotation after initiating an operation of the glass disc by capturing the interference images with a high-speed video camera. The film thickness at the center of the contact region on the ten interference images is obtained, and an average value thereof is set to h_{C}. An ambient temperature during a test is set to 22.5±0.5° C.

In the grease of the invention, it is preferable that a difference between the maximum value (4) and the minimum value (h_{S}) of the film thickness at the contact region is 180 nm or less, and more preferably 110 nm or less.

When the difference between h_{L} and h_{S} is in the preferable range, torque smoothness, particularly, torque smoothness at an initial operation stage is likely to increase.

h_{L} is a value obtained by respectively obtaining the maximum value of the film thickness in the contact region with respect to the ten interference images, and by arithmetically averaging the resultant values. h_{S} is a value that is the minimum among the film thicknesses, which are respectively obtained with respect to the ten interference images, at the center of the contact region.

In addition, h_{C}, h_{L}, and h_{S} are appropriately adjusted by adjusting the kind of component (a base oil or a thickener) that is blended to the grease, or by adjusting grease kneading conditions (a kneading time, the number of times of kneading, a kneading pressure, and the like).

As the apparatus of measuring the film thickness of the EHL film according to the dichromatic interference method, a known method can be used.

In the grease of the invention, the width (T_{w}) of the thickener in the grease is 20 nm or greater, preferably greater than 20 nm, more preferably 30 nm or greater, and still more preferably 40 nm or greater. When T_{W} is 20 nm or greater, durability is enhanced. On the other hand, although not particularly limited, it is preferable that the upper limit of T_{W} is 150 nm or less when considering that the torque smoothness is likely to increase, and more preferably 100 nm or less.

T_{w} is measured as follows.

Method of Measuring Width (T_{W}) of Thickener in Grease

The grease is dispersed in an appropriate solvent (for example, hexane), and is filtrated so as to separate the thickener, the base oil, and the like in the grease. The thickener that is separated onto filter paper is collected, and is dried. The resultant dried thickener is set as a measurement sample.

The thickener, which is the measurement sample, is observed at a magnification of 5000 times to 30000 times by using a scanning electron microscope (SEM). In a case where the thickener that is observed has a fibrous shape, the width (W) at the center in a longitudinal direction of the thickener is measured. W is measured by a scaling function equipped to the SEM. The above-described measurement is performed with respect to five thickeners which are arbitrarily selected, and an average value thereof is set as T_{W}. In addition, the thickener in a lump shape or a bundle shape is excluded from a measurement target. In addition, the thickener that is measured is composed of powders, arbitrary five powders are selected, and an average value of the shortest particle sizes thereof is set as T_{W}.

In addition, T_{W} is appropriately adjusted by adjusting reaction conditions (a reaction temperature, a temperature gradient, and the like) of the thickener, by adjusting a method of manufacturing grease (the thickener is added to the base oil to form grease, or the thickener is generated in the base oil through reaction to form grease), or by adjusting kneading conditions (a kneading time, the number of times of kneading, a kneading pressure, and the like) of the grease.

In addition, it is preferable that h_{C} is set so that a film thickness ratio Λ, which is expressed by the following Expression (1), becomes a value of 1 or greater, more preferably a value of greater than 1, still more preferably a value of 2 or greater, and still more preferably a value of 3 or greater.

Λ=h_{C}/√(Rq₁²+Rq₂²) (1)

Here, Rq₁ and Rq₂ in Expression (1) respectively represent mean square roughness of two sliding components which slide against each other, and √(Rq₁²+Rq₂²) represents composite surface roughness.

For example, in a rolling bearing 22 of an information recording and reproducing apparatus 1 to be described later, two sliding components are an inner ring 30 or an outer ring 31, and a rolling body 33, and Rq₁ is mean square roughness of a rolling surface of the inner ring 30 or the outer ring 31, and Rq₂ is mean square roughness of the rolling body 33.

Typically, in the rolling bearing 22 of the information recording and reproducing apparatus 1 to be described later, Rq₂ is as greatly small as approximately 1/10 times Rq₁, and Expression (1) approximates to Λ=h_{C}/Rq₁. In addition, Rq₁ in the rolling bearing is approximately 20 nm.

Accordingly, in the rolling bearing, it is preferable that h_{C} is 20 nm or greater, more preferably greater than 20 nm, still more preferably 40 nm or greater, and still more preferably 60 nm or greater.

When h_{C} is in the above-described range, two sliding components, that is, the inner ring 30 or the outer ring 31, and the rolling body 33 are prevented from coming into direct contact with each other, and the durability is enhanced.

In addition, it is preferable that T_{W} is equal to or greater than the composite surface roughness of the two sliding components, more preferably greater than the composite surface roughness, still more preferably 1.5 or more times the composite surface roughness, still more preferably 2 or more times the composite surface roughness, and still more preferably 3 or more times the composite surface roughness.

In addition, it is preferable that T_{W} is 7.5 or less times the composite surface roughness, and more preferably 5 or less times the composite surface roughness.

As described above, in the rolling bearing 22 of the information recording and reproducing apparatus 1 to be described later, the composite surface roughness √(Rq₁²+Rq₂²) approximates to Rq₁.

Accordingly, in the rolling bearing, it is preferable that T_{W} is 20 nm or greater, more preferably greater than 20 nm, still more preferably 40 nm or greater, and still more preferably 60 nm or greater.

When T_{W} is in the above-described range, h_{C} is likely to be set in the preferable range, and thus two sliding components, that is, the inner ring 30 or the outer ring 31, and the rolling body 33 is prevented from coming into direct contact with each other. Accordingly, durability is enhanced.

In addition, when T_{W} is in the above-described range, even when the film thickness of grease that is interposed between two sliding components decreases, the thickener is adsorbed to rolling surfaces of the two sliding components, and is interposed between the two components. Accordingly, direct contact between the two sliding components is suppressed, and thus durability is enhanced.

It is preferable that the length (T_{L}) of the thickener is 0.1 μm to 5.0 μm, and more preferably 0.3 μm to 2.0 μm.

T_{L} is measured as follows.

Method of Measuring Width (T_{L}) of Thickener in Grease

The grease is dispersed in an appropriate solvent (for example, hexane), and is filtrated so as to separate the thickener, the base oil, and the like in the grease. The thickener that is separated onto filter paper is collected, and is dried. The resultant dried thickener is set as a measurement sample.

The thickener, which is the measurement sample, is observed at a magnification of 5000 times to 30000 times by using a scanning electron microscope (SEM). In a case where the thickener that is observed has a fibrous shape, the length (L) in the longitudinal direction of the thickener is measured. L is measured by a scaling function equipped to the SEM. The above-described measurement is performed with respect to five thickeners which are arbitrarily selected, and an average value thereof is set as T_{L}. In addition, the thickener in a lump shape or a bundle shape is excluded from a measurement target. In addition, the thickener that is observed is composed of powders, arbitrary five powders are selected, and an average value of the shortest particle sizes thereof is set as T_{L}. The numerical character of the length is an approximate value.

In addition, T_{L} is appropriately adjusted by adjusting reaction conditions (a reaction temperature, a temperature gradient, and the like) of the thickener, by adjusting a method of manufacturing grease (the thickener is added to the base oil to form grease, or the thickener is generated in the base oil through reaction to form grease), or by adjusting kneading conditions (a kneading time, the number of times of kneading, a kneading pressure, and the like) of the grease.

It is preferable that an aspect ratio (T_{L}/T_{W}) of the thickener is 10 to 50, and more preferably 15 to 35.

The film thickness of the base oil, which is interposed between the two sliding components, is proportional to the sliding velocity of the two sliding components, the kinematic viscosity of the base oil.

In a swing arm of HDDs, various operations such as a minute-range and high-speed swing operation and a wide-range and low-speed operation are repeated. Even in the rolling bearing that becomes a rotation supporting point of the swing arm, operations are repeated in conjunction with the various operations. At this time, in the vicinity of both ends of the swing operations, a sliding velocity decreases, the film thickness of the base oil decreases. According to this, it is difficult to avoid the direct contact between the two sliding components.

It may be considered that the kinematic viscosity of the base oil is set to be high so as to increase the film thickness of the base oil that is interposed between the two sliding components. However, in this case, torque is raised. In addition, when the kinematic viscosity of the base oil is set to be high, it is difficult for the base oil to be supplied between the two components during a swing movement, particularly, a swing movement in a minute angle range.

It is advantageous that the kinematic viscosity of the base oil is low when considering that the base oil is easy to be supplied between the two sliding components. However, when the kinematic viscosity of the base oil is set to be low, the film thickness between the components decreases. Particularly, in the vicinity of both ends of the swing operations, the film thickness further decreases at a portion at which the sliding velocity is low or zero, and thus it is difficult to avoid direct contact.

In the invention, as the thickener that constitutes the grease, a thickener having the magnitude that is equal to or greater than a specific width. When using the thickener, even when the sliding velocity is low, the film thickness is retained to be great. Accordingly, it is suppress direct contact between components, and thus it is possible to enhance durability. In addition, the thickener enters between the two sliding components, and is adsorbed to sliding surfaces of the components to suppress direct contact between the components. According to this, even in an environment in which the base oil is difficult to be supplied between sliding components during a swing movement, or even in an environment in which the sliding velocity is low or zero in the vicinity of both ends of swing movements and thus the film thickness of the base oil becomes very small, direct contact between the sliding components is suppressed, and thus durability is enhanced.

Description will be given of a configuration of the grease of the invention.

Base Oil

Although not particularly limited, examples of the base oil that is blended to the grease of the invention include a mineral oil, a synthetic oil, and the like.

As the mineral oil, a mineral oil that is known and is used as the base oil can be used, and examples thereof include a naphthenic mineral oil, a paraffinic mineral oil, a hydrogenated mineral oil, a solvent-refined mineral oil, a highly refined mineral oil, and the like.

As the mineral oil, one kind thereof may be used alone, or two or more kinds thereof may be used in combination. For example, a plurality of mineral oils, which have kinematic viscosities different from each other, may be mixed with each other for adjustment to a target kinematic viscosity (average kinematic viscosity).

As the mineral oil, a refined mineral oil, which is classified as Group III in a base oil category defined by the American petroleum Institute (API), is preferable when considering that grease, in which the amount of outgas is relatively small and heat resistance is excellent, is obtained. Examples of the refined mineral oil include paraffinic mineral oil that is obtained by subjecting a lubricating oil distillate, which is obtained through atmospheric distillation of crude oil, to high hydrogenation refining, and the like.

As the synthetic oil, a synthetic oil that is known and is used as the base oil can be used, and examples thereof include an aliphatic hydrocarbon oil such as poly-α-olefin (PAO) and polybutene, an aromatic hydrocarbon oil such as akylbenzene, alkylnaphthalene, an ester oil such as polyol ester and phosphoric acid ester, an ether oil such as polyphenyl ether, a polyalkylene glycol oil, a silicone oil, a fluorine oil, and the like.

As the synthetic oils, one kind thereof may be used alone, or two or more kinds thereof may be used in combination.

As the synthetic oils, it is preferable to use PAO. As the PAO, PAO that is known and is used as the base oil can be used without limitation, and examples thereof include trimers to pentamers of α-olefin (1-octene, 1-nonene, 1-decene, 1-dodecene, 1-tridecene, 1-tetradecene, 1-pentadecene, 1-hexadecene, 1-heptadecene, 1-octadecene, 1-nonadecene, 1-eicosene, 1-docosene, and the like), a mixture of the trimers to the pentamer, and the like. Among these, as the PAO, the trimers to the pentamers of the α-olefin having 8 to 12 carbon atoms are preferable when considering that the amount of outgas is reduced, and an appropriate viscosity is obtained. As the trimer to pentamers of the α-olefin having 8 to 12 carbon atoms, one kind thereof may be used alone, or two or more kinds thereof may be used in combination.

As the PAO, one kind thereof may be used alone, or two or more kinds thereof may be used in combination. For example, a plurality of kinds of PAO, which have kinematic viscosities different from each other, may be mixed with each other for adjustment to a target kinematic viscosity (average kinematic viscosity).

As the base oil, it is preferable to use the mineral oil and the PAO in combination. In this case, it is preferable that a proportion of the mineral oil in 100% by mass of base oil is 10% by mass to 40% by mass. In addition, it is preferable that the proportion of the mineral oil contained in the base oil is greater than the proportion of the PAO contained in the base oil.

In addition, it is preferable that a kinematic viscosity ν₁ of the mineral oil at 40° C. is set to be higher than a kinematic viscosity ν₂ of the PAO at 40° C. When the kinematic viscosity ν₁ of the mineral oil is higher than the kinematic viscosity ν₂ of the PAO, heat resistance of the mineral oil is likely to be enhanced. As a result, the amount of outgas from the mineral oil decreases, and as a result, the amount of outgas from the base oil is likely to decrease. In addition, when the PAO having kinematic viscosity ν₂ lower than the kinematic viscosity ν₁ of the mineral oil is used in combination, the kinematic viscosity ν of the base oil is lowered. According to this, it is easy to supply the grease to a portion of the rolling bearing at which rolling bodies are rolled. Accordingly, it is easy to obtain a lubricating effect due to the grease.

In addition, the kinematic viscosity of the oil in the invention represents a value that is measured at 40° C. in conformity to JIS K 2283.

In addition, in a case where a plurality of the same kind of base oils, which have kinematic viscosities different from each other, are mixed, an average kinematic viscosity of the entirety of the base oils is regarded as a kinematic viscosity.

It is preferable that a ratio ν₁/ν₂ of the kinematic viscosity ν₁ of the mineral oil to the kinematic viscosity ν₂ of the PAO is 1.3 or greater when considering that it is easy to further reduce the amount of outgas, and more preferably 1.5 or greater. In addition, it is preferable that the ratio ν₁/ν₂ is 4 or less in consideration of low torque of the rolling bearing, and more preferably 2 or less.

It is preferable that the kinematic viscosity ν₁ of the mineral oil is 40 mm²/s or greater when considering that it is easier to reduce the amount of outgas, and more preferably 45 mm²/s or greater. In addition, it is preferable that the kinematic viscosity ν₁ of the mineral oil is 80 mm²/s or less when considering that it is easy to supply the grease or the base oil to a rolling surface of the rolling bearing, and more preferably 60 mm²/s or less.

It is preferable that the kinematic viscosity ν₂ of the PAO is 20 mm²/s or greater when considering that it is easy to further reduce the amount of outgas, and more preferably 30 mm²/s or greater. In addition, it is preferable that the kinematic viscosity ν₂ of the PAO is 60 mm²/s or less when considering that it is easy for the rolling bodies to supply the grease or the base oil to the rolling surface of the rolling bearing, and more preferably 40 mm²/s or less.

It is preferable that the kinematic viscosity ν of the base oil at 40° C. is 25 mm²/s to 45 mm²/s, and more preferably 30 mm²/s to 40 mm²/s. When the kinematic viscosity ν of the base oil is equal to or greater than the lower limit, it is ease to further reduce the amount of outgas. When the kinematic viscosity ν of the base oil is equal to or less than the upper limit, it is easy to supply the grease or the base oil to the rolling surface of the rolling bearing. In addition, it is easy to perform an operation with low torque even in a use in which a stable operation at a low temperature is demanded (for example, an in-vehicle use in which a stable operation is demanded even at a low temperature of −30° C.). Particularly, in a case where the proportion of the mineral oil in 100% by mass of base oil is 30% by mass or less, when the kinematic viscosity ν of the base oil at 40° C. is 25 mm²/s or greater, it is easy to reduce the amount of outgas.

The kinematic viscosity of the base oil at 40° C. is not limited to the numerical range, and the viscosity may be raised in a range without a problem of torque increase (including characteristics at a low temperature) or a problem related to supply of the grease to the sliding members during a sliding movement.

When the kinematic viscosity of the base oil at 40° C. is set to 25 mm²/s to 45 mm²/s, particularly, the viscosity of the base oil significantly decreases at a high temperature (80° C.). According to this, when a rotation velocity of the bearing is raised (for example, 100 mm/s), an oil film hc that is obtained by the base oil itself becomes very thin, and may be frequently thinner than the composite surface roughness of two sliding components. As a countermeasure thereof, it is also effective to raise the viscosity of the base oil, but there is limitation for the upper limit. In this case, when the width (T_{W}) of the thickener is set to be equal to or greater than the composite surface roughness of the two sliding components, it is possible to suppress direct contact between the two sliding components even under any operation condition.

Thickener

The thickener has a function of maintaining the grease in a semi-solid shape.

As the thickener, a thickener that is known and is typically used in the grease for a rolling bearing of an information recording and reproducing apparatus without limitation. Examples of the thickener include include a urea compound, lithium soap, calcium soap, composite lithium soap, composite calcium soap, silica gel, polytetrafluoroethylene, an organized bentonite, and the like. Among these, as the thickener, the urea compound is preferable in consideration of excellent heat resistance, and a diurea compound having two urea bonds in one molecular is more preferable.

Examples of the diurea compound include an aliphatic diurea compound of which the end is an aliphatic group, an alicyclic diurea compound of which the end is an alicyclic group, an aromatic diurea compound of which the end is an aromatic group, and the like.

Examples of an aliphatic hydrocarbon group of an aliphatic diurea compound include an aliphatic hydrocarbon group having 8 to 18 carbon atoms, and the like.

Specific examples of the diurea compound include a compound that is obtained through a reaction between diisocyanate (phenylene diisocyanate, tolylene diisocyanate, and the like) and monoamine (octylamine, dodecylamine, stearylamine, cyclohexylamone, aniline, p-toluidine, and the like).

Examples of the lithium soap include lithium stearate, lithium 12-hydroxystearate, and the like.

As the thickener, one kind thereof may be used alone, or two or more kinds thereof may be used in combination.

Other Components

The grease of the invention may contain other components other than the above-described components as necessary

As the other components, a component that is known and is typically used in the grease can be used, and examples thereof include an additive such as an extreme pressure agent, an antioxidant, an antirust agent, an oiliness improver, and a metal deactivator.

Examples of the extreme pressure agent include an organic molybdenum compound (molybdenum dithiocarbamate, molybdenum dithiophosphate, and the like), an organic fatty acid compound (oleic acid, naphthenic acid, succinic acid, and the like), an organic phosphorus compound (trioctyl phosphate, triphenyl phosphate, triethyl phosphate, and the like), phosphorus acid ester, zinc dithiocarbamate, antimony dithiocarbamate, and the like.

As the extreme pressure agent, one kind thereof may be used alone, or two or more kinds thereof may be used in combination.

Examples of the antioxidant include phenol-based antioxidant (2,6-di-t-butylphenol, 2,6-di-t-butyl-4-methylphenol, tetrakis [methylene-3-(3′,5′-di-t-butyl-4′-hydroxyphenyl)propionate]methane, octyl-3,5-di-t-butyl-4-hydroxy-hydrocinnamon acid, 2-(2′-hydroxy-3′-t-butyl-5′-methylphenyl)-5-chlorobenzotriazole, and the like), an amine-based antioxidant (phenyl-2-naphthylamine, diphenylamine, di(4-octylphenyl)amine, phenylene diamine, and the like), and the like.

As the antioxidant, one kind thereof may be used alone, or two or more kinds thereof may be in combination.

Examples of the antirust agent include an alkali metal salt or an alkaline-earth metal salt of an organic sulfonic acid (calcium sulfonate, magnesium sulfonate, barium sulfonate, and the like), partial ester of polyhydric alcohol (sorbitan monooleate, and the like), and the like.

As the antirust agent, one kind thereof may be used alone, or two or more kinds thereof may be used in combination.

Proportion of Each Component

It is preferable that a proportion of the base oil in 100% by mass of grease of the invention is 75% by mass to 93% by mass, and more preferably 80% by mass to 90% by mass. When the proportion of the base oil is equal to or greater than the lower limit, it is easy to supply the grease or the base oil to the rolling surface of the rolling bearing. When the proportion of the base oil is equal to or less than the upper limit, the grease has a semi-solid shape, and leakage is less likely to occur. Accordingly, scattering is less likely to occur.

It is preferable that the proportion of the mineral oil in 100% by mass of base oil is 10% by mass to 40% by mass, and more preferably 20% by mass to 30% by mass. When the proportion of the mineral oil is equal to or greater than the lower limit, it is easy to obtain grease that is well-balanced between excellent durability and torque smoothness. When the proportion of the mineral oil is equal to or less than the upper limit, it is easy to obtain grease in which the amount of outgas is sufficiently reduced.

It is preferable that a proportion of the PAO in 100% by mass of base oil is 50% by mass to 90% by mass, and more preferably 60% by mass to 80% by mass. When the proportion of the PAO is equal to or greater than the lower limit, it is easy to obtain grease in which the amount of outgas is sufficiently reduced. When the proportion of the PAO is equal to or less than the upper limit, it is easy to obtain grease that is well-balanced between the excellent durability and the torque smoothness.

It is preferable that a proportion of the sum of the mineral oil and the PAO in 100% by mass of base oil is 70% by mass or greater, more preferably 80% by mass or greater, and still more preferably 90% by mass or greater. When the proportion of the sum of the mineral oil and the PAO is equal to or greater than the lower limit, it is easy to obtain low-torque grease. The upper limit of the proportion of the sum of the mineral oil and the PAO is 100% by mass.

In the grease of the invention, it is preferable that the proportion of the mineral oil in the base oil is greater than the proportion of the PAO when considering that the reduction of the amount of outgas and the excellent durability is likely to be compatible with each other.

It is preferable that a mass ratio (PAO/mineral oil) of the PAO to the mineral oil in the base oil is 1.25 to 9, and more preferably 1.5 to 4. When the mass ratio is equal to or greater than the lower limit, it is easy to reduce the amount of outgas. When the mass ratio is equal to or less than the upper limit, it is easy to enhance durability and torque smoothness.

It is preferable that a proportion of the thickener in 100% by mass of grease of the invention is 7% by mass to 20% by mass, and more preferably 10% by mass to 15% by mass. When the proportion of the thickener is equal to or greater than the lower limit, it is easy to obtain grease in which leakage is less likely to occur, and scattering is less likely to occur. When the proportion of the thickener is equal to or less than the upper limit, it is easy to supply the grease or the base oil to the rolling surface of the rolling bearing.

It is preferable that a proportion of the extreme pressure agent in 100% by mass of grease of the invention is 0.2% by mass to 4% by mass, and more preferably 0.5% by mass to 2% by mass.

It is preferable that a proportion of the antirust agent in 100% by mass of grease of the invention is 0.2% by mass to 4% by mass, and more preferably 0.5% by mass to 2% by mass.

Information Recording and Reproducing Apparatus

The rolling bearing, the rolling bearing device, and the information recording and reproducing apparatus of the invention can employ other aspects which are known except that the grease of the invention is used. Hereinafter, description will be given with reference to an example of the rolling bearing, the rolling bearing device, and the information recording and reproducing apparatus of the invention.

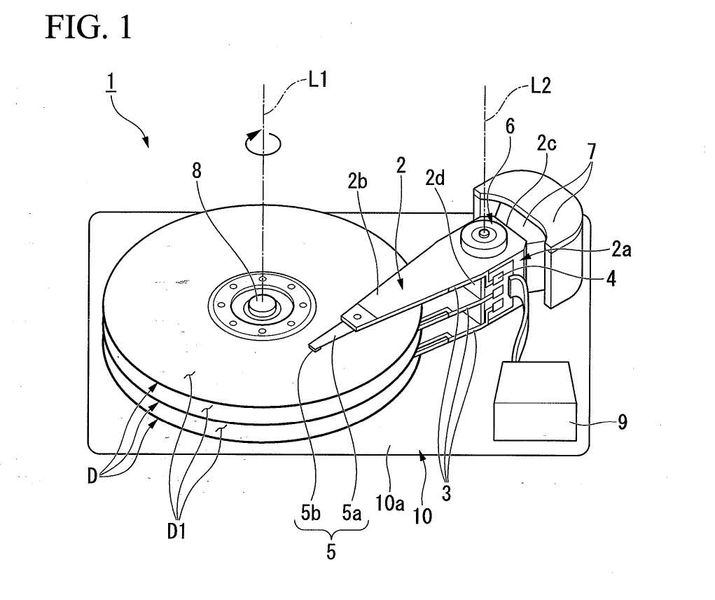

An information recording and reproducing apparatus 1 of this embodiment is an apparatus that performs writing with respect to a disc (magnetic recording medium) D in a vertical recording type, and includes the disc D, a swing arm 2, an optical waveguide 3, a laser light source 4, a head gimbal assembly (HGA) 5, a rolling bearing device 6, an actuator 7, a spindle motor (rotation drive unit) 8, a control unit 9, and a housing 10 as illustrated in FIG. 1.

The housing 10 accommodates respective constituent portions in the information recording and reproducing apparatus 1.

The housing 10 includes the bottom 10a having a rectangular shape in a plan view, a peripheral wall portion (not illustrated) that erects from a peripheral edge of the bottom 10a, and a cover body (not illustrated) that is detachably fixed to an upper portion of the peripheral wall portion and covers an opening. The housing 10 is configured to accommodate respective constituent components on an inner side of the peripheral wall portion on the bottom 10a. In FIG. 1, the peripheral wall portion and the cover body are omitted for convenience.

A material of the housing 10 is not particularly limited, and examples thereof include a metal material such as aluminum.

The spindle motor 8 is attached to approximately the center of the bottom 10a of the housing 10. In addition, the spindle motor 8 is configured to be inserted into a central hole that is formed at the center of the disc D, and three sheets of the disc D are mounted in a detachable manner. The spindle motor 8 is configured to rotate each of the discs D around a rotation axial line L1 in a constant direction.

The actuator 7 is mounted to be positioned on an outer side of the disc D at one corner portion of the bottom 10a of the housing 10. The swing arm 2, which extends toward the disc D, is connected to the actuator 7. The rolling bearing device 6 is provided to a portion on a base end side of the swing arm 2. The swing arm 2 is configured to rotate around a rotation axial line L2 of the rolling bearing device 6 in a horizontal plane by driving of the actuator 7.

The swing arm 2 includes a base portion 2a that is connected to the actuator 7, and an arm portion 2b that extends from the base portion 2a toward the disc D. For example, the swing arm 2 can be obtained by integrally forming the base portion 2a and the arm portion 2b through machining.

The base portion 2a has an approximately rectangular parallelepiped shape, and is rotatably supported to the rolling bearing device 6 so as to surround the rolling bearing device 6.

The arm portion 2b has a plat plate shape, and is configured in a tapered shape that is narrowed as it goes toward a tip end portion from a base end portion. The arm portion 2b is provided to extend from a front surface (surface opposite to a corner portion) 2d of the base portion 2a, which is opposite to a rear surface 2c to which the actuator 7 is attached, in a plane direction (direction in a horizontal plane) of an upper surface of the base portion 2a.

In addition, in the swing arm 2 in this example, three sheets of the arm portions 2b are provided in a height direction (vertical direction) of the base portion 2a in order for the disc D to be interposed between the arm portions 2b, respectively. That is, each of the arm portions 2b and the disc D are arranged to be alternately positioned in the height direction, and the arm portion 2b is configured to move in a direction parallel to a disc surface (surface of the disc D) D1 by driving of the actuator 7.

The head gimbal assembly 5 is provided to the tip end of the arm portion 2b of the swing arm 2. The laser light source 4 is provided to a lateral surface portion of the base portion 2a of the swing arm 2. The optical waveguide 3, which connects the laser light source 4 and the head gimbal assembly 5, is provided to the base portion 2a and the arm portion 2b of the swing arm 2. According to this, it is possible to supply light from the laser light source 4 to the head gimbal assembly 5 through the optical waveguide 3.

The head gimbal assembly 5 includes a suspension 5a, and a slider 5b that is attached to a tip end of the suspension 5a.

The slider 5b includes a near-field light generating element. When light is guided to the slider 5b from the laser light source 4, near-field light is generated from the near-field generating element. It is possible to record or reproduce various kinds of information on or from the disc D by using the near-field light.

For example, the near-field light generating element is constituted by an optical minute opening, a protrusion that is formed in a nanometer size, and the like.

The head gimbal assembly 5 moves in a direction parallel to the disc surface D1 in combination with the arm portion 2b of the swing arm 2 by driving of the actuator 7. In addition, when the rotation of the disc D is stopped, the swing arm 2 and the head gimbal assembly 5 is configured to retreat from the disc D by driving of the actuator 7.

The control unit 9 is connected to the laser light source 4. The control unit 9 is configured to control a luminous flux of light that is supplied to the slider 5b of the head gimbal assembly 5 by a current that is modulated in accordance with information.

Rolling Bearing Device

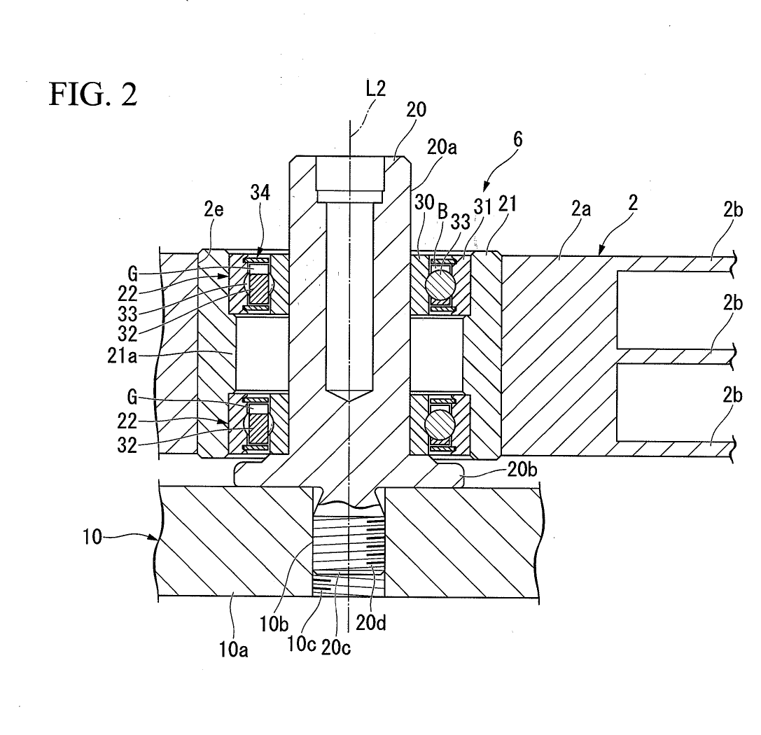

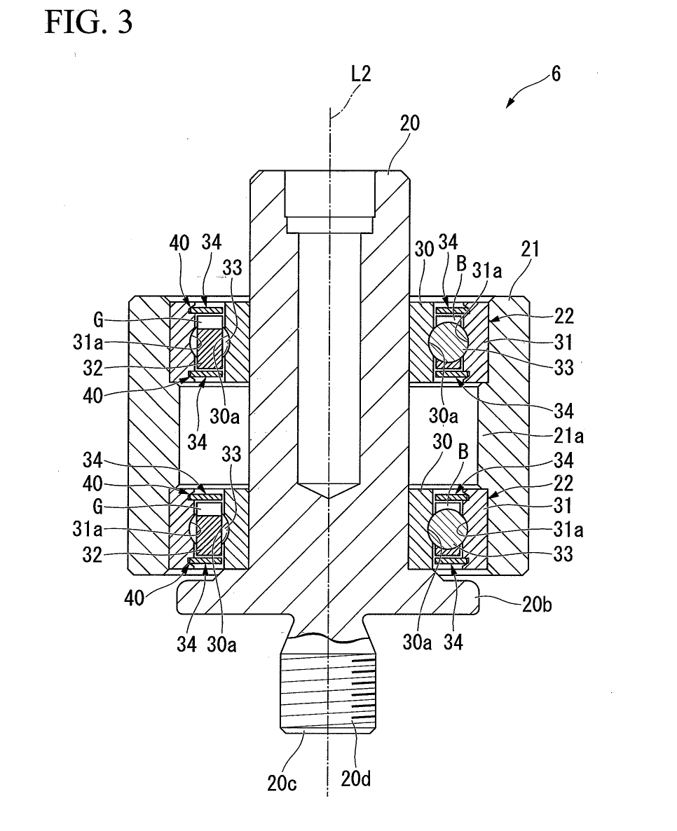

As illustrated in FIGS. 2 and 3, the rolling bearing device 6 includes a shaft 20, a sleeve 21 that is provided on an outer side of the shaft 20 to be concentric with the shaft 20, and two rolling bearings 22 which are provided between the shaft 20 and the sleeve 21.

The shaft 20 is a rod-shaped member having a columnar shape, and erects from the bottom 10a of the housing 10. A central axis of the shaft 20 becomes the rotation axial line L2 during rotation of the swing arm 2.

At a portion of the shaft 20 on a bottom 10a side of the housing 10, a flange portion 20b having a diameter enlarged from that of a main body portion 20a, and a reduced diameter portion 20c of which a diameter is reduced from that of the main body portion 20a are sequentially provided toward a base end. A male screw 20d is formed on an outer circumferential surface of the reduced diameter portion 20c. The reduced diameter portion 20c of the shaft 20 is inserted into a hole 10b that is provided in the bottom 10a of the housing 10, and a female screw 10c that is formed on an inner circumferential surface of the hole 10b and the male screw 20d of the reduced diameter portion 20c engage with each other. According to this, the shaft 20 erects from the bottom 10a of the housing 10. At this time, when a lower surface of the flange portion 20b is bonded to the bottom 10a of the housing 10, positioning of the shaft 20 in a height direction is made.

The sleeve 21 is a member that is formed in a cylindrical shape. An inner diameter of the sleeve 21 is approximately the same as an outer diameter of the flange portion 20b.

The sleeve 21 is provided to surround the shaft 20 from an outer side in a diameter direction, and an inner circumferential surface thereof is spaced from an outer circumferential surface of the shaft 20 with a predetermined interval. A central axis of the shaft 20 and a central axis of the sleeve 21 are concentric with each other.

In addition, the sleeve 21 may be pressed into a mounting hole 2e that is formed in the base portion 2a of the swing arm 2 directly or through an elastic body such as a corrugated metal ring, or may be bonding-fitted into the mounting hole 2e. According to this, the sleeve 21 and the swing arm 2 are integrally combined with each other.

A spacer portion 21a, which protrudes toward an inner side over the entire circumference in a circumferential direction, is formed at the central portion of the inner circumferential surface of the sleeve 21 in a height direction. Two rolling bearings 22 are provided between the shaft 20 and the sleeve 21 on an upper side and a lower side of the spacer portion 21a, respectively, and a gap between the two rolling bearings 22 is maintained to a predetermined distance.

Rolling Bearing

The two rolling bearings 22 which are provided to the rolling bearing device 6 are the same as each other.

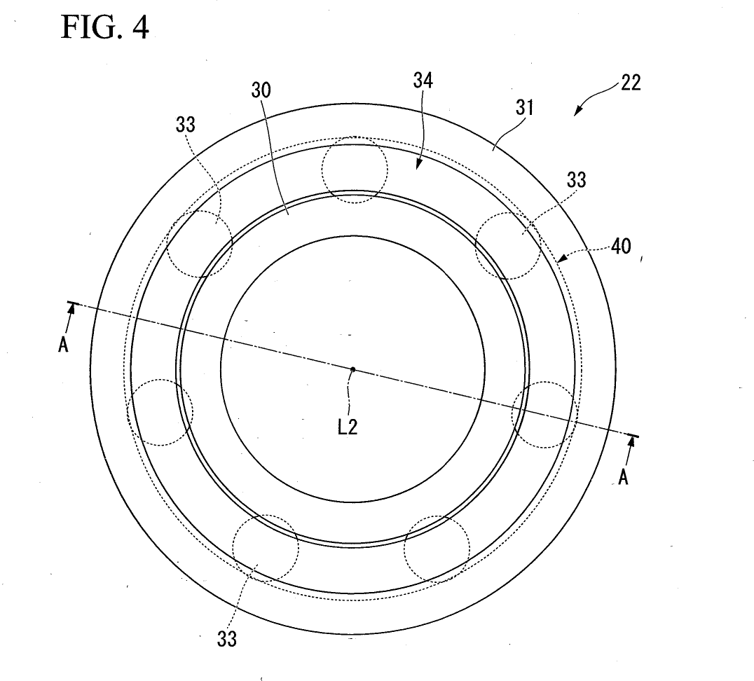

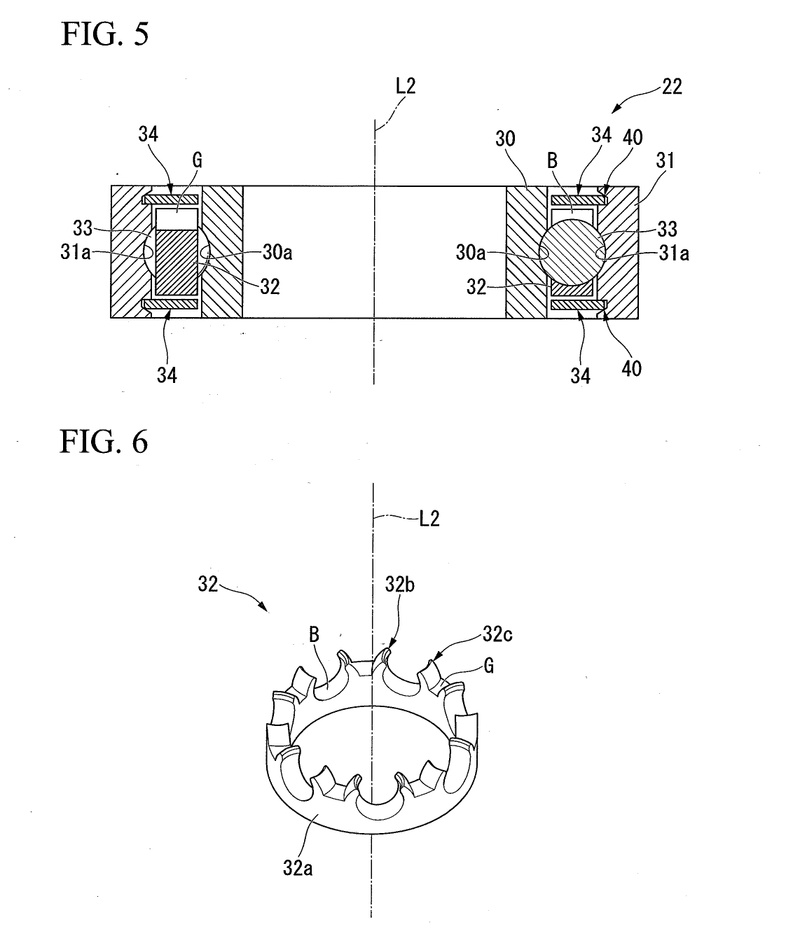

As illustrated in FIGS. 3 to 6, the rolling bearing 22 includes an inner ring 30, an outer ring 31, a retainer 32, a plurality of rolling bodies 33, and two shield plates 34.

The bearing that is used in PIVOT has an inner diameter of approximately 4 mm to 7 mm, an outer diameter of approximately 7 mm to 10 mm, and a width of approximately 1 mm to 3.5 mm. A ball diameter is approximately 0.8 mm to 1 mm. Typically, the number of balls is approximately 11 to 13. Stainless steel is used for the inner and outer rings, and bearing steel (SUJ2) or the same stainless steel as in the inner and outer rings is used for the ball. As a pressure that is applied, approximately 200 gf to 1200 gf is used.

The inner ring 30 is a cylindrical member.

An inner diameter of the inner ring 30 is set to dimensions with which the shaft 20 can be inserted into the inner ring 30. In this embodiment, the inner diameter of the inner ring 30 is set to be slightly greater than an outer diameter of the shaft 20. The shaft 20 is inserted to an inner side of the inner ring 30, and the inner ring 30 is fixed to the shaft 20 with an adhesive and the like.

In addition, the inner diameter of the inner ring 30 may be the same as the outer diameter of the shaft 20 or slightly smaller than the outer diameter as long as the inner diameter is in a range capable of being installed to the shaft 20. In this case, the shaft 20 is pressed into and fixed to the inner ring 30.

In the rolling bearing 22, it is possible to employ a so-called inner ring pre-load type in which the inner ring 30 is fixed to the shaft 20 in a state in which a pre-load is applied to the inner ring 30 relatively to the shaft 20 in an axial direction. According to this, it is possible to make the rolling bearing 22 have high rigidity, and it is possible to raise a resonance frequency (resonance point) of the rolling bearing device 6. As a result, the rolling bearing device 6 can cope with a relatively high-speed rotation.

In addition, in the rolling bearing 22, it is also possible to employ a so-called outer ring pre-load type in which the outer ring 31 is fixed to the sleeve 21 in a state in which a pre-load is applied to the outer ring 31 relatively to the shaft 20 in an axial direction.

At an intermediate portion of the outer circumferential surface of the inner ring 30 in the axial direction, an inner ring rolling surface 30a, which is a recessed strip that guides rolling of the rolling bodies 33, is formed over the entire circumference of the inner ring 30. In the inner ring rolling surface 30a, when cutting the inner ring 30 along a plane passing through the central axis of the inner ring 30, a cross-sectional shape is an arc shape.

Examples of a material of the inner ring 30 include a metal material such as stainless steel. For example, the inner ring 30 can be manufactured by forging, machining, and the like.

The outer ring 31 is member that has a diameter greater than that of the inner ring 30, and has the same cylindrical shape as that of the inner ring 30.

The outer ring 31 is fixed to an inner side of the sleeve 21, and is provided on an outer side of the inner ring 30 in a state of being spaced from the inner ring 30. The inner ring 30 and the outer ring 31 are provided to be concentric with each other so that central axes thereof match the central axis of the shaft 20.

At an intermediate portion of the inner circumferential surface of the outer ring 31 in the axial direction, an outer ring rolling surface 31a, which is a recessed strip that guides rolling of the rolling bodies 33, is formed over the entire circumference of the outer ring 31 to face the inner ring rolling surface 30a of the inner ring 30. In the outer ring rolling surface 31a, when cutting the outer ring 31 along a plane passing through the central axis of the outer ring 31, a cross-sectional shape is an arc shape.

Examples of a material of the outer ring 31 include a metal material such as stainless steel. For example, the inner ring 30 can be manufactured by forging, machining, and the like.

As illustrated in FIG. 6, the retainer 32 includes an annular main body portion 32a, and seven pairs of hook portions 32b and 32c which are formed on an upper portion of the main body portion 32a and erect in an arc shape in such a manner that a distance therebetween becomes narrow as it goes toward a tip end. The seven pairs of hook portions 32b and 32c are provided at even intervals in a circumferential direction of the retainer 32. A ball pocket B, which retains each of the rolling bodies 33 in a rolling manner and has an approximately circular shape when viewed from a front side, is formed on an inner side of each pair of the hook portion 32b and the hook portion 32c.

In addition, the number of the pairs of the hook portions, that is, the number of the ball pocket B is not limited to 7, and may be 6 or less, or 8 or greater.

An inner diameter of the retainer 32 is set to be larger than an outer diameter of the inner ring 30, and an outer diameter of the retainer 32 is set to be smaller than an inner diameter of the outer ring 31. In a state in which the retainer 32 is provided between the inner ring 30 and the outer ring 31, the rolling body 33 is retained in each ball pocket B in a rolling manner. As described above, in a state in which the inner ring 30, the outer ring 31, and the retainer 32 do not interfere with each other, the rolling body 33 is disposed between the inner ring rolling surface 30a of the inner ring 30 and the outer ring rolling surface 31a of the outer ring 31.

The retainer 32 is configured to rotate around the central axis L2 in a state in which the rolling body 33 is retained in each ball pocket B in a rolling manner.

Although not particularly limited, examples of a material of the retainer 32 include a resin such as a polyamide resin.

A grease pocket G, which has a depth shallower than that of the ball pocket B, is formed between a pair of the hook portions 32b and 32c, and an adjacent pair of the hook portions 32b and 32c on an upper side of the retainer 32. That is, in the retainer 32, the ball pocket B and the grease pocket G are alternately formed in a circumferential direction due to the plurality of pairs of hook portions 32b and 32c.

When the retainer 32 and the rolling body 33 rotate in a state in which the grease of the invention is disposed in the grease pocket G, and the rolling body 33 is disposed in the ball pocket B, the grease bleeds out from the grease pocket G to a space between the inner ring 30, the outer ring 31, and the rolling body 33, and a lubricating effect to the grease is obtained.

When the grease is used in the rolling bearing 22 by using the grease pocket G, it is possible to reduce the amount of the grease that is used. According to this, it is easy to suppress an increase in torque on the rolling bearing 22 due to an excessive amount of the grease, and it is easy to obtain sufficient cleanness that is demanded for writing and reading to and from the disc D.

In this example, the rolling body 33 has a spherical shape. The rolling body 33 is disposed in the ball pocket B of the retainer 32 between the inner ring rolling surface 30a of the inner ring 30 and the outer ring rolling surface 31a of the outer ring 31, and rolls along the inner ring rolling surface 30a and the outer ring rolling surface 31a. Respective rolling bodies 33 are equally arranged in the circumferential direction due to the retainer 32.

In this example, the number of the rolling bodies 33 is 7. However, the number of the rolling bodies 33 may be determined in accordance with the number of the ball pockets B in the retainer 32, and may be 6 or less or 8 or greater.

Examples of a material of the rolling body 33 include a metal material such as bearing steel.

The shied plates 34 are ring-shaped plate members which cover an upper side and a lower side of an annular space that is formed between the inner ring 30 and the outer ring 31. The shield plates 34 are provided on an upper side and a lower side of the retainer 32 and the plurality of rolling bodies 33, respectively, between the inner ring 30 and the outer ring 31. Each of the shield plates 34 is fixed to the outer ring 31 in a state in which an outer peripheral portion enters a circular groove 40 for engaging which is formed in the outer ring 31.

Operation Mechanism

In the information recording and reproducing apparatus 1, the grease of the invention is disposed in the grease pocket G of the retainer 32 in the rolling bearing 22. When the swing arm 2 rotates by driving of the actuator 7, the grease, which is disposed in the grease pocket G, passes through a lateral surface of the inner ring 30, the outer ring 31, and the retainer 32, and is supplied to a space between the inner ring 30, the outer ring 31, and the rolling bodies 33. According to this, the lubricating effect of the grease is exhibited.

In the information recording and reproducing apparatus 1, since the grease of the invention is used, the amount of outgas is sufficiently reduced. According to this, outgas is less likely to be collected in a gap between the head gimbal assembly and the disc D. As a result, it is possible to stably perform reading and writing. In addition, it is possible to secure excellent durability, and it is possible to maintain a state in which torque smoothness is excellent with low torque over a long period of time.

### OTHER EMBODIMENTS

Furthermore, the rolling bearing, the rolling bearing device, and the information recording and reproducing apparatus of the invention are not limited to the above-described configurations as long as the grease of the invention is used.

For example, the information recording and reproducing apparatus 1 including the rolling bearing 22 and the rolling bearing device 6 uses near-field light, but may be a typical HDD or optical disc D device including a rolling bearing and a rolling bearing device which use the grease of the invention, and the like.

In addition, the rolling bearing device may not include the sleeve. Specifically, it is possible to employ a rolling bearing device that includes a ring-shaped spacer ring, which maintains a gap between the rolling bearings to a predetermined distance, between the two rolling bearings which are disposed to be spaced away from each other in an axial direction on an outer side of the shaft, and does not include the sleeve. In this case, it is possible to employ an aspect in which the outer ring of the rolling bearing is directly pressed into or bonding-fitted into the mounting hole that is formed in the base portion of the swing arm.

In addition, the rolling bodies in the rolling bearing may be cylindrical rollers.

### EXAMPLES

Hereinafter, the invention will be described in detail with reference to Examples, but the invention is not limited by the following description.

The kinematic viscosity of the mineral oil, the PAO, and the base oil in Examples was measured at 40° C. in conformity to JIS K 2283 by using a Cannon-Fenske viscometer.

### Examples 1 to 5, and Reference Example 1

Grease in each of Examples 1 to 5 was prepared as follows.

### Example 1

A refined mineral oil (classified as Group III in the API base oil category. The kinematic viscosity ν₁: 47 mm²/s), and the PAO (the kinematic viscosity ν₂: 30 mm²/s) were mixed in a mass ratio of 3:7 to obtain a base oil (the kinematic viscosity ν: 34 mm²/s).

Aliphatic monoamine and diisocyanate were added to the base oil, and were allowed to react in the base oil at 60° C. to 80° C. to generate aliphatic diurea (thickener), and the reaction product was heated to the highest temperature of 200° C., thereby obtaining grease. An antioxidant, an antirust agent, and an extreme pressure agent were added to the grease, and the resultant mixture was kneaded with a three-roll mill to prepare grease in Example 1.

As the proportion of the respective components in 100% by mass of grease, the base oil was set to 85.0% by mass, the thickener was set to 12.5% by mass, the antioxidant was set to 0.5% by mass, the antirust agent was set to 1.0% by mass, and the extreme pressure agent was set to 1.0% by mass.

### Example 2

Grease in Example 2 was obtained in the same manner as in Example 1 except that aliphatic monoamine and diisocyanate were added to the same base oil as in Example 1, and were allowed to react in the base oil at 60° C. to 80° C. to generate aliphatic diurea, and the reaction product was heated to the highest temperature of 180° C.

As the proportion of the respective components in 100% by mass of grease, the base oil was set to 85.0% by mass, the thickener was set to 12.5% by mass, the antioxidant was set to 0.5% by mass, the antirust agent was set to 1.0% by mass, and the extreme pressure agent was set to 1.0% by mass.

### Examples 3 and 4

Grease in Example 3 and grease in Example 4 were prepared in the same manner as in Example 2 except that kneading conditions (the number of times of passing through rolls, and roll fastening pressure) of the three-roll mill were changed.

### Example 5

Grease in Example 5 was prepared in the same manner as in Example 2 except that the extreme pressure agent was not added.

As the proportion of the respective components in 100% by mass of grease, the base oil was set to 86.0% by mass, the thickener was set to 12.5% by mass, the antioxidant was set to 0.5% by mass, and the antirust agent was set to 1.0% by mass.

### Reference Example 1

As Reference Example 1, commercially available grease α for the rolling bearing of the information recording and reproducing apparatus was used. In addition, the grease α contains a urea compound as the thickener, and PAO and a mineral oil as the base oil.

With respect to grease in each of Examples 1 to 5, and Reference Example 1, h_{C} and T_{W} were measured as follows. In addition, with respect to the grease, measurement of the amount of outgas, an oxidation stability test, a durability test, a grease bump test, a torque smoothness test, and an abrasion resistance test were performed as follows. Results are illustrated in Table 1.

Measurement of Film Thickness h_{C} of EHL Film

A steel ball was brought into rolling-contact with a surface of a glass disc to which the grease was applied, and the film thickness of a contact region at that time was obtained by the dichromatic interference method.

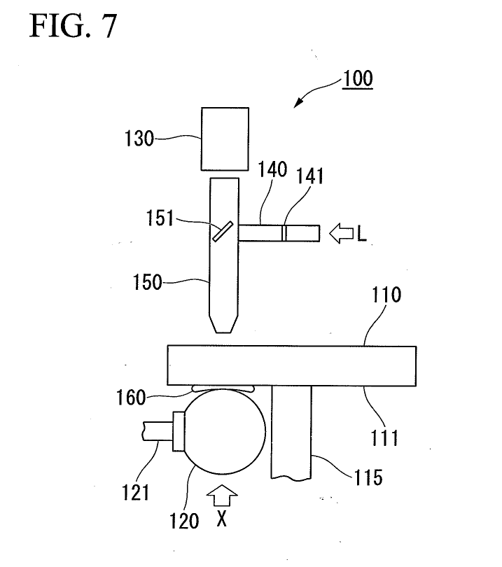

A measurement apparatus 100 illustrated in FIG. 7 was used as an apparatus of measuring the film thickness of the EHL film in accordance with the dichromatic interference method.

The measurement apparatus 100 includes a disc-shaped glass disc 110 which includes a chromium film 111, which is formed through deposition of chromium, on a lower surface. The glass disc 110 is pivotally supported to a rotation axis 115 that allows the glass disc 110 to rotate in a peripheral direction.

A steel ball 120 for a bearing is provided on a lower side of the glass disc 110, and the steel ball 120 for a bearing is rotatably supported to a rotation shaft 121. In addition, the steel ball 120 for a bearing is supported by a roller (not illustrated) from a lower side thereof in order for an arbitrary contact load X to be applied to the steel ball 120 for a bearing.

A reflective optical path 150 is provided on an upper side of the glass disc 110, and an incident optical path 140, to which light beams L emitted from a light source (not illustrated) are incident, is connected to a portion of the reflective optical path 150 partway along a longitudinal direction thereof. A high-speed video camera 130 is provided on an upper side of the reflective optical path 150. An optical filter 141, through which light beams having a specific wavelength among the light beams L are transmitted, is provided partway through the incident optical path 140, and a mirror 151, which transmits the light beams transmitted through the optical filter 141 to the glass disc 110, is provided partway through the reflective optical path 150.

As the glass disc, a glass disc having a diameter of 115 mm, a thickness of 16 mm, and a vertical elastic coefficient of 75 GPa was used. As the steel ball, a steel ball for a bearing, which has a diameter of 19.05 mm, and a vertical elastic coefficient of 206 GPa, was used. The contact load X between the glass disc 110 and the steel ball 120 for a bearing is set to 150 N, and the maximum hertz pressure is set to 1.04 GPa.

Next, description will be given of a method of measuring the film thickness h_{C} of the EHL film by using the measurement apparatus 100.

The light beams L, which are emitted from the light source (not illustrate), are converted into light beams, which are mainly composed of a light beam having a wavelength of 555 nm (green) and a light beam having a wavelength of 640 mu (red), by the optical filter 141 that is provided partway through the incident optical path 140. The light beams are transmitted to the glass disc 110 by the mirror 151 that is provided partway through the reflective optical path 150, and are reflected from the chromium film 111 formed on a lower surface of the glass disc 110, and a surface of the steel ball 120 for a bearing. At this time, an interference fringe is generated due to a difference in an optical path between a reflected light beam that is reflected from the chromium film 111, and a reflected light beam that is reflected from the surface of the steel ball 120 for a bearing.

An image of the interference fringe is captured by the high-speed video camera 130 to obtain an interference image. The film thickness of the EHL film of the grease 160, which is interposed between the chromium film 111 and the steel ball 120 for a bearing, was obtained from the interference image in accordance with a calibration table created in advance.

With regard to a grease application method, the grease was uniformly applied to a region, which becomes an orbital surface of the steel ball 120 for a bearing, of the chromium-deposited surface of the glass disc 110 in a thickness that is sufficiently greater than the film thickness of the EHL film of the grease which is assumed (for example, in order for the thickness of the grease applied to be 0.3 mm) by using a spatula. After initiating operation of the glass disc 110 in a state in which the peripheral velocity of the glass disc was set to 1 mm/s, ten interference images were captured for one rotation with the high-speed video camera 130. The film thickness at the center of the contact region on the ten interference images was obtained, and an average value thereof is set to h_{C}. An ambient temperature during a test was set to 22.5±0.5° C. In addition, after one rotation from initiation of the operation, the thickness of the grease, which was applied to the orbital surface of the steel ball 120 for bearing in the glass disc 110, was observed, and it was confirmed that the thickness became smaller than the thickness of the grease that was initially applied, and a grease bank occurred on both sides, that is, the grease was sufficiently supplied between the glass disc 110 and the steel ball 120 for a bearing. In addition, for reference, a part of the calibration table is illustrated in Table 2.

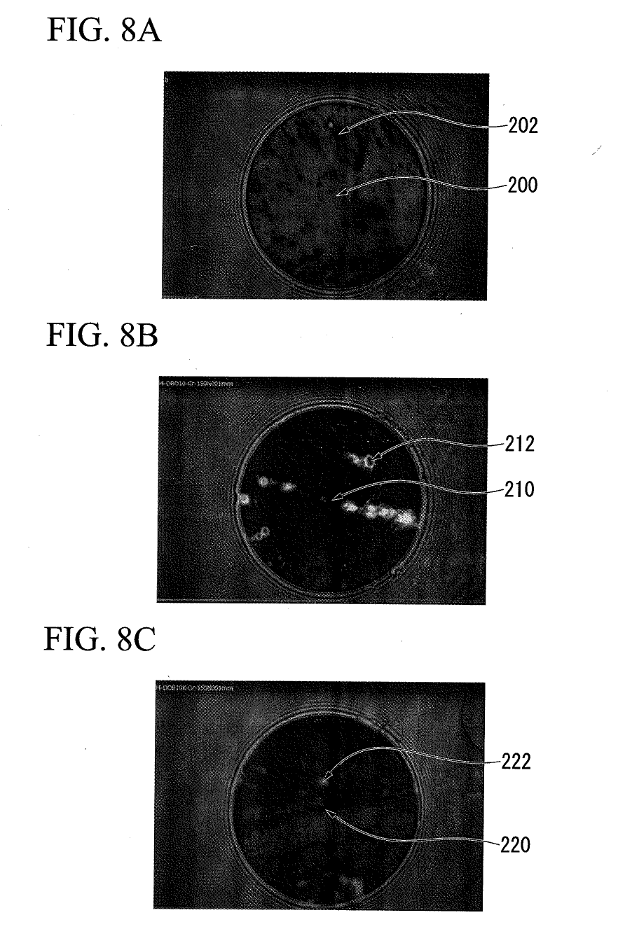

FIGS. 8A to 8C illustrate an example of the interference image of the EHL film which is observed with the measurement apparatus in FIG. 7. FIG. 8A is an interference image of the EHL film that is observed with respect to the grease in Reference Example 1. FIG. 8B is an interference image of the EHL film that is observed with respect to the grease in Example 1. FIG. 8C is an interference image of the EHL film that is observed with respect to the grease in Example 2.

In FIGS. 8A to 8C, a circular region is a contact region between the glass disc 110 and the steel ball 120 for a bearing. The center of the contact region is the center of the circular region (center of a circle).

In addition, from a calibration table that was created in advance, the film thicknesses at the centers 200, 210, and 220 of the contact regions in FIGS. 8A to 8C were 17 nm, 60 nm, and 60 nm, respectively. h_{C} of the invention is a value obtained by respectively obtaining the film thickness at the center of the contact region with respect to ten interference images observed for each grease, and by arithmetically averaging the resultant film thicknesses.

In addition, 202 in FIG. 8A, 212 in FIG. 8B, and 222 in FIG. 8C are sites at which the film thicknesses in the respective interference images become the maximum, and the film thicknesses are 60 nm, 219 nm, and 149 nm, respectively. In the invention, the maximum value (10 of the film thickness at the contact region is a value obtained by respectively obtaining the maximum value of the film thickness at the contact region with respect to the ten interference images, and by arithmetically averaging the resultant maximum values. In addition, in the invention, the minimum value (h_{S}) of the film thickness at the contact region is a minimum value among the film thicknesses at the center of the contact region which are respectively obtained with respect to the ten interference images.

In the operation at a low velocity (peripheral velocity: 1 mm/s), the film thickness of the EHL film of Reference Example 1 (the commercially available grease α for a rolling bearing of an information recording and reproducing apparatus) was 17 nm (FIG. 8A). As described above, typically, the composite surface roughness of the rolling bearing 22 of the information recording and reproducing apparatus 1 is approximately 20 nm. The film thickness of the EHL film of Reference Example 1 (the commercially available grease α) became smaller than the composite surface roughness of the rolling bearing 22 of the information recording and reproducing apparatus 1 in the operation at a low velocity.

In contrast, the film thickness of the EHL film of the grease in Example 1 and the grease in Example 2 are 60 nm (FIG. 8B and FIG. 8C) are sufficiently greater than the composite surface roughness. The reason for this is considered as follows. In the invention, since the size of the thickener (the width of the thickener) is adjusted, even in the low-velocity environment, it is possible to maintain the film thickness of the EHL film to a great value. According to this, even in the low-velocity environment, the grease of the invention can suppress direct contact between sliding components, and thus it is possible to enhance durability.

Measurement of Width of Thickener in Grease

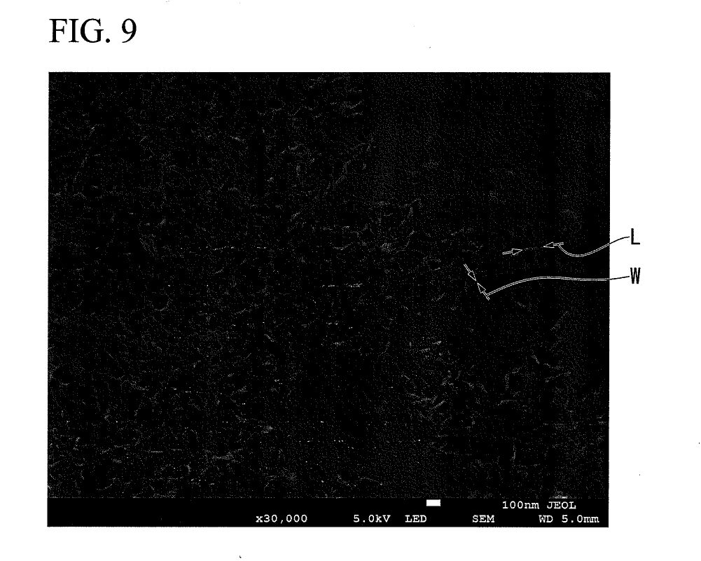

FIGS. 9 to 11 illustrate a SEM image of the thickener which is observed by using a SEM. A magnification was set to 5000 times to 30000 times (in addition, when raising the magnification, focusing becomes difficult, and thus observation was performed at a low magnification as much as possible).

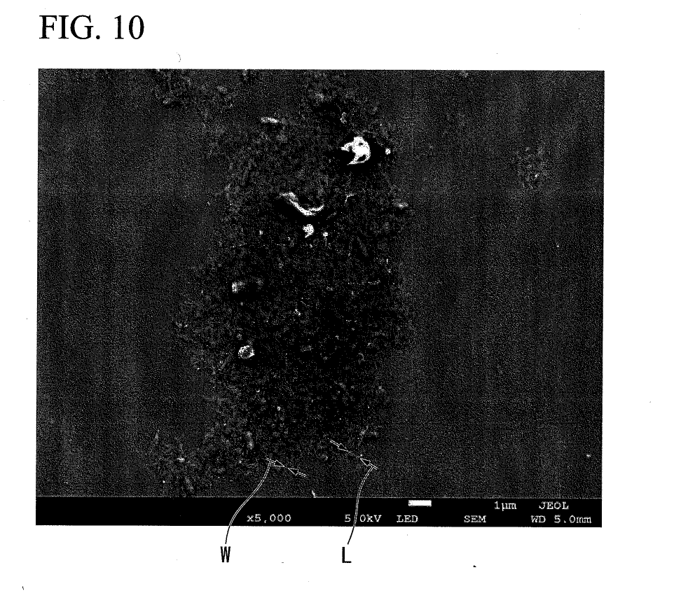

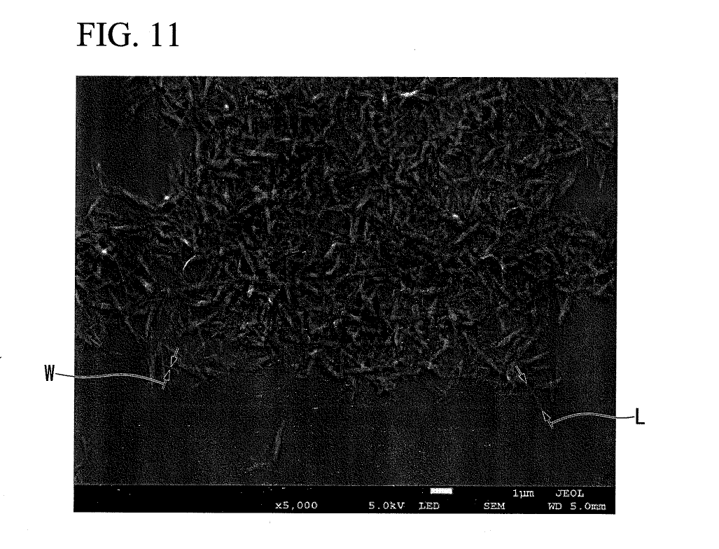

FIG. 9 is a SEM image (30000 times) of the thickener of Reference Example 1. FIG. 10 is a SEM image (5000 times) of the thickener in the grease in Example 1. FIG. 11 is a SEM image (5000 times) of the thickener in the grease in Example 2.

W in FIGS. 9 to 11 represents the width (W) at the center in the longitudinal direction of the thickener in each grease, and is 15 nm in FIG. 9, 30 nm in FIG. 10, and 40 nm in FIG. 11.

T_{W} in the invention is a value obtained by performing the measurement with respect to five thickeners which are arbitrarily selected for the thickener of each grease, and by arithmetically averaging the resultant measured values.

Durability Test

The rolling bearing device 6 illustrated in FIGS. 3 to 6 was prepared. Then, the grease in each of Examples was disposed in the grease pocket G of the retainer 32, and a continuous operation was performed under the following operation conditions to measure a torque variation width (hashing) as a torque ratio of torque after the continuous operation to initial torque before the continuous operation.

Operation Conditions

Operation frequency: 30 Hz

Operation angle: 10 deg

Operation time: 100 hours

Operation environmental temperature: 80° C.

Grease Bump Test

The rolling bearing device 6 illustrated in FIGS. 3 to 6 was prepared. Then, grease in each of Examples was disposed in the grease pocket G of the retainer 32, and a continuous operation was performed under the following operation conditions to measure torque immediately after the continuous operation. The, evaluation was performed in accordance with the following standards.

Operation Conditions

Operation frequency: 15 Hz

Operation angle: 5 deg

Operation time: 50 hours

Operation environmental temperature: Room temperature

Evaluation Standards

O: Torque immediately after the continuous operation hardly varies from the initial torque before the continuous operation.

x: Torque immediately after the continuous operation greatly varies from the initial torque before the continuous operation.

Torque Smoothness Test

The rolling bearing device 6 illustrated in FIGS. 3 to 6 was prepared, and grease in each of Examples was disposed in the grease pocket G of the retainer 32. A variation width of torque when rolling once (initial stage) after initiating the operation of the rolling bearing device 6 was measured, and evaluation was performed according to the following evaluation standards. In addition, when the variation width of torque at the initial stage is great, there is a possibility that control of a reading or writing operation from or on a disk may be affected.

Evaluation Standards

O: Variation width of torque at the initial stage is approximately the same as a variation width in Reference Example 1.

Δ: Variation width of torque at the initial stage is slightly greater than the variation width in Reference Example 1 (level at which control of reading or writing operation from or on a disk is not affected).

x: Variation width of torque at the initial stage is greater than a variation width in Reference Example 1 (there is a possibility that control of reading or writing operation from or on a disk may be affected).

Abrasion Resistance Test

An abrasion resistance test was performed in conformity to ASTM D2783 by using a four-ball tester under conditions of a load of 392 N, the number of revolutions of 1,200 rpm, an oil temperature of 75° C., and test time of 60 minutes. Abraded diameters of three balls of ½ inches in the four-ball tester were measured, and an average value thereof was calculated.

TABLE 1

| | | | | | | | Reference |
|---|---|---|---|---|---|---|---|
| | | | | | | | Example |
| | | Example 1 | Example 2 | Example 3 | Example 4 | Example 5 | Grease α |
| Film thickness of | h_{C} (nm) | 98 | 79 | 66 | 95 | 79 | 19 |
| EHL film | h_{L} (nm) | 219 | 124 | 60 | 171 | 124 | 60 |
| | h_{S} (nm) | 39 | 60 | 60 | 60 | 60 | 17 |
| | h_{L} − h_{S} (nm) | 180 | 64 | 0 | 111 | 64 | 43 |
| Width of thickener | T_{W} (nm) | 28 | 45 | 44 | 47 | 45 | 17 |
| Length of thickener | T_{L} (μm) | 0.5 | 1.5 | 1.5 | 1.5 | 1.5 | 0.25 |

| | | | | | | |
|---|---|---|---|---|---|---|
| Durability test | 1.2 | 1.6 | 1.5 | 1.7 | 1.8 | 5 |
| (torque variation width) times | | | | | | |
| Grease bump test | ◯ | ◯ | ◯ | ◯ | ◯ | X (six times) |
| Torque smoothness test (nm) | X | ◯ | ◯ | Δ | ◯ | (Reference) |
| Abrasion resistance test | 0.57 | 0.59 | 0.60 | 0.58 | 0.66 | 0.99 |

TABLE 2

| | | Film |
|---|---|---|
| | | thickness |
| No. | color | (μm) |
| 1 | .01B | 0.0085 |
| 2 | 01B | 0.0170 |
| 3 | 01B. | 0.0386 |
| 4 | 1B | 0.0603 |
| 5 | .1B1Y | 0.0921 |
| 6 | 1B1Y | 0.124 |
| 7 | 1B1Y. | 0.136 |
| 8 | 1Y | 0.149 |
| 9 | .1Y1DR | 0.160 |
| 10 | 1Y1DR | 0.171 |
| 11 | 1Y1DR. | 0.195 |
| 12 | 1DR | 0.237 |

As illustrated in Table 1, in the grease in each of Examples 1 to 5 in which h_{C} satisfies the range of the invention, a variation in torque was small in any of the durability test and the grease bump test, and excellent durability was exhibited. In addition, in the grease in each of Examples 1 to 5, the abraded diameter in the abrasion resistance test was small, and the abrasion resistance was excellent.

In addition, in the grease in each of Examples 2 to 5, the torque smoothness was excellent than the torque smoothness of the grease in Example 1 in which a difference between h_{L} and h_{S} is 180 nm. In addition, the present inventors performed the torque smoothness test with respect to grease containing a urea thickener in which T_{W} is 156 nm, and they confirmed that evaluation in the torque smoothness test was not good even though a lump of the thickener was not observed in the grease.

In addition, in the grease in Example 1, the torque variation width was greater in comparison to the commercially available grease α in Reference Example 1 in the torque smoothness test, but a ratio between torque before the continuous operation and torque after the continuous operation is smaller than the ratio in the grease α in Reference Example 1. From this, it is apparent that the grease in Example 1 has durability more excellent than durability of the commercially available grease α in Reference Example 1.

On the other hand, in the commercially available grease α, the torque variation width in the durability test was great, and durability thereof was inferior to durability of the grease in each of Examples 1 to 5. In addition, in the grease bump test, torque after the continuous operation became six times torque before the continuous operation in the grease bump test. The reason for this is considered to be because grease, which deteriorates through oxidation, is collected to both end portions of an operation range in the continuous operation to form a bump, or abrasion occurs violently at the both end portions (portions at which sliding velocity is low or zero) of the operation range in the continuous operation.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1: Information recording and reproducing apparatus
2: Swing arm
3: Optical waveguide
4: Laser light source
5: Head gimbal assembly
6: Rolling bearing device
7: Actuator
8: Spindle motor
9: Control unit
10: Housing
20: Shaft
21: Sleeve
22: Rolling bearing
30: Inner ring
31: Outer ring
32: Retainer
33: Rolling body
34: Shield plate
B: Ball pocket
G: Grease pocket

What is claimed is:

1. Grease for a rolling bearing of an information recording and reproducing apparatus, comprising:
a base oil; and
a thickener,
wherein the film thickness (h_{C}) of an elasto-hydrodynamic lubrication film, which is measured by the following measurement method, is 20 nm or greater.
<Method of Measuring Film Thickness (h_{C}) of Elasto-hydrodynamic Lubrication film>
A steel ball is brought into rolling-contact with a surface of a glass disc to which grease is applied, and the film thickness of a contact region is obtained by a dichromatic interference method.
As the glass disc, a glass disc, in which chromium is deposited on a single surface and which has a diameter of 115 mm, a thickness of 16 mm, and a vertical elastic coefficient of 75 GPa, is used. As the steel ball, a steel ball for a bearing, which has a diameter of 19.05 mm, and a vertical elastic coefficient of 206 GPa, is used.
Grease is applied to a surface of the glass disc on which chromium is deposited. The glass disc and the steel ball are brought into contact with each other under pure rolling conditions of a contact load of 150 N and a maximum hertz pressure of 1.04 GPa. A peripheral velocity of the glass disc is set to 1 mm/s, and ten interference images are obtained for one rotation after initiating an operation of the glass disc. The film thickness at the center of the contact region on the ten interference images is obtained, and an average value thereof is set to h_{C}. An ambient temperature during a test is set to 22.5±0.5°.

2. The grease for a rolling bearing of an information recording and reproducing apparatus according to claim 1,
wherein a difference between the maximum value and the minimum value of the film thickness at the contact region is 180 nm or less.

3. The grease for a rolling bearing of an information recording and reproducing apparatus according to claim 1,
wherein the film thickness (h_{C}) is equal to or greater than composite surface roughness of a rolling surface of an inner ring and a rolling body, and composite surface roughness of a rolling surface of an outer ring and the rolling body in the rolling bearing.

4. Grease for a rolling bearing of an information recording and reproducing apparatus, comprising:
a base oil; and
a thickener,
wherein a width of the thickener in the grease is 20 nm or greater.

5. The grease for a rolling bearing of an information recording and reproducing apparatus according to claim 4,
wherein the width of the thickener is 150 nm or less.

6. The grease for a rolling bearing of an information recording and reproducing apparatus according to claim 4,
wherein the width of the thickener is equal to or greater than composite surface roughness of a rolling surface of an inner ring and a rolling body, and composite surface roughness of a rolling surface of an outer ring and the rolling body in the rolling bearing.

7. The grease for a rolling bearing of an information recording and reproducing apparatus according to claim 1,
wherein a kinematic viscosity ν of the base oil at 40° C. is 25 mm²/s to 45 mm²/s.

8. A rolling bearing, comprising:
the grease for a rolling bearing of an information recording and reproducing apparatus according to claim 1.

9. A rolling bearing device, comprising:
a shaft; and
the rolling bearing according to claim 8

10. An information recording and reproducing apparatus, comprising:
the rolling bearing device according to claim 9.
